(19) United States
(12) Patent Application Publication
(10) Pub. No.: US 2023/0356019 A1
(43) Pub. Date: Nov. 9, 2023

(54) EASY CHAIR

(71) Applicant: TOYOTA BOSHOKU KABUSHIKI KAISHA, Aichi (JP)

(72) Inventors: Yasuhiro KATO, Aichi (JP); Masaya KITO, Aichi (JP)

(73) Assignee: TOYOTA BOSHOKU KABUSHIKI KAISHA, Aichi (JP)

(21) Appl. No.: 18/131,093

(22) Filed: Apr. 5, 2023

(30) Foreign Application Priority Data
May 9, 2022 (JP) 2022-077030

(51) Int. Cl. A63B 21/005; B60N 2/02; A63B 24/00; A63B 21/00; A63B 23/035; A63B 23/04

(52) U.S. Cl. CPC A63B 21/0058; B60N 2/0232; B60N 2/0244; A63B 24/0087; A63B 21/15; A63B 21/4047; A63B 23/03525; A63B 23/0494; B60N 2002/0236; A63B 2208/0233

(57) ABSTRACT

The present disclosure provides one example of an easy chair in light of market trends related to health and fitness. The easy chair of the present disclosure includes a movable portion configured to change a seated posture, and further includes a moving mechanism that includes at least an electric actuator and is configured to displace the movable portion, and a controller configured to control an operation of the electric actuator and perform a posture change mode and a muscle strength training mode.

### CROSS-REFERENCE TO RELATED APPLICATIONS

This application claims the benefit of Japanese Patent Application No. 2022-077030 filed on May 9, 2022 with the Japan Patent Office, the entire disclosure of which is incorporated herein by reference.

### BACKGROUND

The present disclosure relates to an easy chair.

As disclosed in Japanese Unexamined Patent Application Publication No. H5-137630, an easy chair includes a movable portion for changing a seated posture.

### SUMMARY

In recent years, attention has been focused on markets related to health and fitness. The present disclosure discloses one example of an easy chair in light of market trends related to health and fitness.

An easy chair may comprise, for example, at least one of the following elements.
Movable portion for changing a seated posture.
Moving mechanism: a moving mechanism comprising at least an electric actuator and configured to displace the movable portion.
Controller: a controller configured to control an operation of the electric actuator and perform a posture change mode and a muscle strength training mode. Herein, the posture change mode is a mode that allows the movable portion to be displaced so as to change the seated posture. The muscle strength training mode is a mode that allows a user to perform muscle strength training utilizing a motion resistance generated when the user applies a force to the movable portion to displace the movable portion.

The user of the easy chair is able to perform the muscle strength training by utilizing the movable portion for changing the seated posture. In the easy chair, the movable portion for changing the seated posture is utilized in a muscle strength training, thus avoiding adding another movable portion exclusively for the muscle strength training. Accordingly, the easy chair has a muscle strength training function, while being relatively lightweight, space-saving, and inexpensive.

The easy chair of the present disclosure may comprise the following configurations, for example.

The electric actuator is an electric motor. The moving mechanism comprises a deceleration mechanism. The deceleration mechanism is a gear mechanism comprising two or more gears and configured to decelerate a rotation of the electric motor and output the decelerated rotation to the movable portion. The motion resistance is a rotational resistance generated when a rotational force is applied to an output side of the deceleration mechanism to rotate the two or more gears. The easy chair can inhibit addition of a movable portion exclusively for the muscle strength training.

The controller may rotate the electric motor so as to assist displacement of the movable portion when the muscle strength training mode is performed. This allows easy control of a load during performance of the muscle strength training mode.

The easy chair of the present disclosure may comprise an external force detector configured to detect an external force applied to the movable portion. The controller may rotate the electric motor based on a magnitude of the external force detected with the external force detector. The easy chair may comprise a fixing portion to be directly or indirectly fixed to a vehicle.

### BRIEF DESCRIPTION OF THE DRAWINGS

An embodiment of the present disclosure will be described hereinafter by way of example with reference to the accompanying drawings, in which:

FIG. 1 is a diagram of an easy chair according to one embodiment of the present disclosure;

FIG. 2 is a diagram showing an operation of the easy chair according to one embodiment of the present disclosure; and

FIG. 3 is a graph showing one example of a relation between an external force and a motor output.

### DETAILED DESCRIPTION OF EXEMPLARY EMBODIMENTS

An embodiment described hereinafter is one example of embodiments within the technical scope of the present disclosure. Matters specifying the invention that are recited in the appended claims are not limited to any specific configuration, structure, or the like that is shown in the embodiment described below.

The present embodiment describes an example where an easy chair is a seat (hereinafter referred to as a “vehicle seat”) to be installed in a vehicle, such as an automobile. Arrows indicating directions, hatched lines, and so on in the figures are shown so as to facilitate understanding of mutual relationships among the figures, shapes of members or portions, and so on.

The easy chair is not limited by the directions shown in the figures. The directions shown in the figures correspond to directions in a state where the vehicle seat of the present embodiment is assembled in a vehicle.

At least a member or portion described with a reference numeral assigned thereto is at least one in number unless accompanied by a specifying term, such as “only one”. That is, the member or portion may be two or more in number if no specifying term, such as “only one”, is present. The easy chair of the present disclosure comprises at least elements including members and portions described with respective reference numerals assigned thereto, and structural portions shown in the drawings.

1. Outline of Easy Chair (Vehicle Seat)

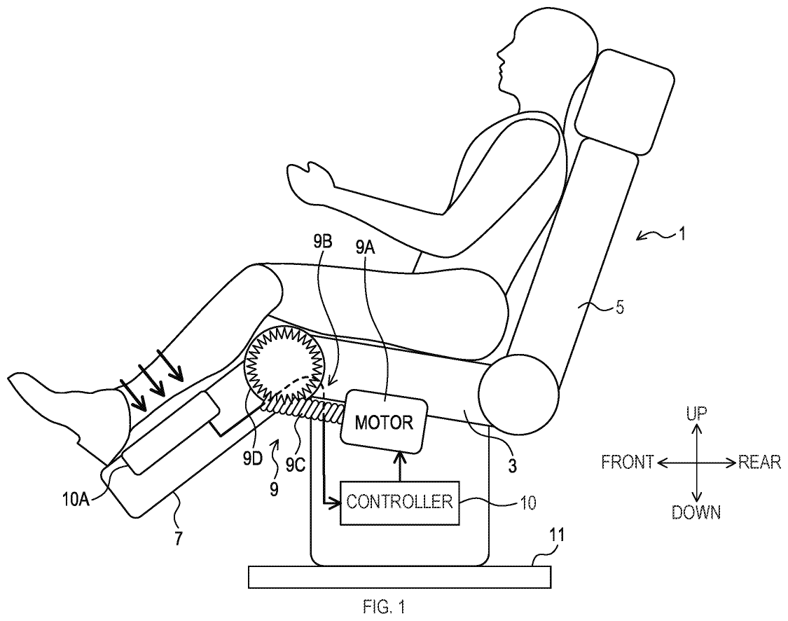

As shown in FIG. 1, an easy chair 1 comprises a seat cushion 3, a seatback 5, and an ottoman 7. The seat cushion 3 supports buttocks of an occupant. The seatback 5 supports a back of the occupant.

The ottoman 7 supports legs, particularly calves, of the occupant. The seatback 5 and the ottoman 7 are displaceable with respect to the seat cushion 3.

The seatback 5 is arranged on a rear end side of the seat cushion 3, and is pivotable about a lower end part of the seatback 5 in seat front-rear directions. The ottoman 7 is arranged on a front end side of the seat cushion 3, and is pivotable around an upper end part of the ottoman 7 in the seat front-rear directions.

This allows the occupant seated on the easy chair 1 to choose a seated posture that makes the occupant feel comfortable. Examples of a movable portion to change the seated posture correspond to the seatback 5 and the ottoman 7.

The seatback 5 and the ottoman 7 receive a drive force from an electrical moving mechanism and are thereby displaced. For example, a moving mechanism 9 for the ottoman 7 comprises an electric motor 9A and a deceleration mechanism 9B.

The electric motor 9A is one example of an electric actuator that generates a drive force. The deceleration mechanism 9B comprises two or more gears, and decelerates a rotation of the electric motor 9A, thereby to increase a rotational force of the electric motor 9A and output the increased rotational force to the ottoman 7.

The deceleration mechanism 9B comprises a worm 9C and a worm wheel (helical gear) 9D. The rotational force of the electric motor 9A is input to the worm 9C. An output from the worm wheel 9D is input to the ottoman 7.

The easy chair 1 further comprises a sliding device 11. The sliding device 11 is one example of a fixing portion configured to directly or indirectly fix the easy chair 1 to a vehicle. The sliding device 11 may comprise a mechanism that allows the easy chair 1 to be switched between a displaceable state and a non-displaceable state.

2. Controller

2.1 Outline of Controller and Related Components

The easy chair 1 further comprises a controller 10 and a pressure sensor 10A. The controller 10 controls an operation of the electric motor 9A. The controller 10 is configured with a microcomputer including a CPU, a ROM, a RAM, and so on.

The electric motor 9A is controlled by execution of software by the CPU. The software is stored in advance in a non-volatile storage device (not shown), such as a ROM.

The pressure sensor 10A is one example of an external force detector configured to detect an external force applied to the ottoman 7. For example, when the occupant performs a motion of pressing the calves on the ottoman 7, the pressure sensor 10A detects a pressure generated on an outer surface of the ottoman 7 due to such motion, and transmits to the controller 10 a signal corresponding to the detected pressure.

2.2. Control by Controller

The controller 10 is configured to perform a posture change mode and a muscle strength training mode. A user of the easy chair 1, such as the occupant, can choose any of the modes by manipulating a mode selection switch (not shown).

The posture change mode indicates a mode that allows the ottoman 7 to be displaced so as to change the seated posture. The muscle strength training mode indicates a mode that allows the user to perform muscle strength training (for purpose of improving muscle strength) by utilizing a motion resistance generated when the ottoman 7 is displaced.

The motion resistance is a rotational resistance generated when the worm 9C, the worm wheel 9D, and a rotor (not shown) of the electric motor 9A are rotated in a case in which the rotational force is applied to an output side of the deceleration mechanism 9B.

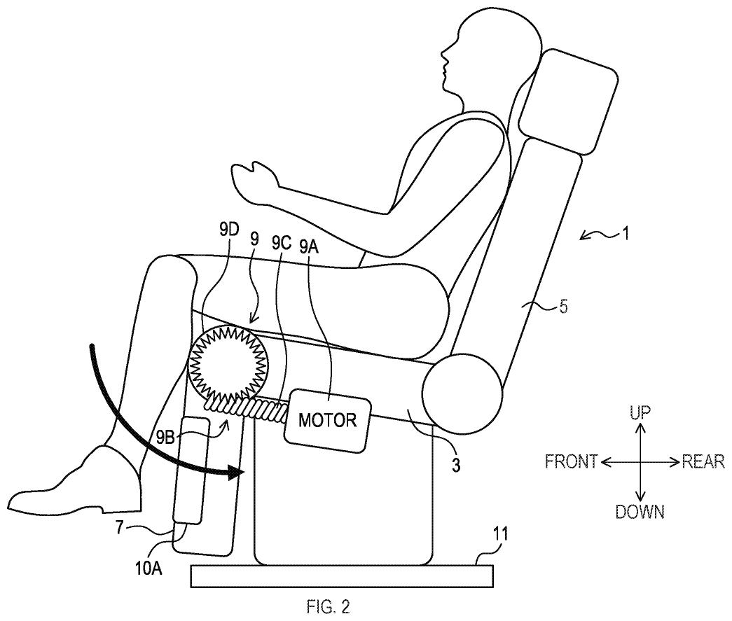

In the muscle strength training mode, the user applies a force to the ottoman 7 (see FIG. 2). At this time, the controller 10 rotates the electric motor 9A so as to assist displacement of the ottoman 7.

Specifically, when the user applies the force to the ottoman 7 in a direction illustrated by an arrow in FIG. 1, the controller 10 rotates the electric motor 9A based on a magnitude of the external force detected by the pressure sensor 10A, such that the ottoman 7 is displaced in the direction illustrated by an arrow in FIG. 2.

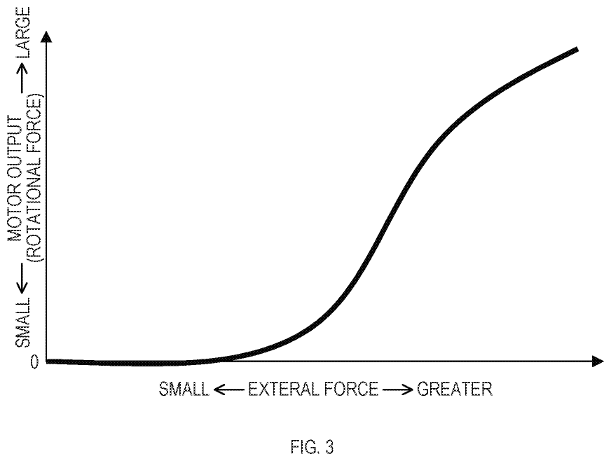

As shown in FIG. 3, the controller 10 controls the electric motor 9A such that the output (rotational force) of the electric motor 9A increases as the external force detected by the pressure sensor 10A becomes greater.

3. Features of Easy Chair in Present Embodiment

The easy chair 1 allows performing the posture change mode and the muscle strength training mode. This enables the user of the easy chair 1 to perform the muscle strength training by utilizing the movable portion (for example, the ottoman 7) for changing the seated posture.

Further, since the ottoman 7 for changing the seated posture is utilized, it is possible to inhibit addition of a movable portion exclusively for the muscle strength training. Accordingly, a muscle strength training function can be added to the easy chair 1 in a lightweight, space-saving, and inexpensive manner.

In the muscle strength training mode of the easy chair 1, the rotational resistance, which is generated when the two or more gears forming the deceleration mechanism 9B are rotated, is utilized to produce a load during performance of the muscle strength training mode (hereinafter, referred to as a “training load”). Accordingly, the easy chair 1 can inhibit addition of a movable portion exclusively for the muscle strength training.

The training load in the muscle strength training mode of the easy chair 1 is maximized in a state where no displacement assistance from the electric motor 9A is provided. The greater the displacement assistance from the electric motor 9A is, the smaller the training load is. In the muscle strength training mode, the training load may be easily controlled through the control of the electric motor 9A.

### OTHER EMBODIMENTS

The controller 10 in the aforementioned embodiment rotates the electric motor 9A so as to assist the displacement of the ottoman 7 when the muscle strength training mode is performed. However, the present disclosure is not limited thereto.

For example, the controller 10 may control the electric motor 9A so as to generate a braking force (a regenerative braking force) in the electric motor 9A. Such control enables the maximum training load to be greater than that in the aforementioned embodiment.

In the aforementioned embodiment, the external force applied to the movable portion, such as the ottoman 7, is detected by the pressure sensor 10A. However, the present disclosure is not limited thereto.

For example, the external force applied to the ottoman 7 may be detected by detecting a displacement acceleration of the ottoman 7 and utilizing the detected acceleration. Conceivable detection methods of a displacement acceleration include, for example, a detection method utilizing a magnitude of a counter electromotive force generated in the electric motor 9A, and a method of providing an acceleration sensor on to the ottoman 7.

In the aforementioned embodiment, the output of the electric motor 9A is controlled in accordance with the magnitude of the external force applied to the movable portion, such as the ottoman 7. However, the present disclosure is not limited to such configuration. For example, the electric motor 9A may be controlled to provide a training load preset by a user.

The easy chair 1 in the aforementioned embodiment may comprise a storage device that to stores exercise history data. Further, the easy chair 1 may comprise a device such as a display to show exercise history, degrees of improvement in exercise, and so on. Such configuration enhances user's motivation.

In the aforementioned embodiment, the ottoman 7 is utilized as the movable portion for the muscle strength training mode, but the present disclosure is not limited thereto. For example, other movable portions, such as a seatback, may be utilized to perform the muscle strength training mode.

In the aforementioned embodiment, an example of a vehicle seat has been described, but the present disclosure is not limited thereto. For example, the easy chair of the present disclosure may also be applied to seats for use in other vehicles, such as railroad vehicles, ships and boats, and aircrafts, as well as built-in seats for use in theaters, households, and so on. The built-in seats may omit a sliding device forming the fixing portion.

The present disclosure should not be limited to the aforementioned embodiments, but may be implemented in any embodiment that falls within the spirit of the disclosure described in the aforementioned embodiments. Accordingly, the present disclosure may include a configuration obtained by combining at least two of the aforementioned embodiments or a configuration obtained by omitting some of the elements described in the drawings or the elements described with reference numerals in the aforementioned embodiment.

What is claimed is:

1. An easy chair comprising:
a movable portion configured to change a seated posture;
a moving mechanism comprising at least an electric actuator and configured to displace the movable portion; and
a controller configured to control an operation of the electric actuator and perform a posture change mode and a muscle strength training mode,
wherein the posture change mode is a mode that allows the movable portion to be displaced so as to change the seated posture, and
wherein the muscle strength training mode is a mode that allows a user to perform muscle strength training utilizing a motion resistance generated when the user applies a force to the movable portion to displace the movable portion.

2. The easy chair according to claim 1, wherein
the electric actuator is an electric motor,
the moving mechanism comprises a deceleration mechanism,
the deceleration mechanism is a gear mechanism comprising two or more gears and configured to decelerate a rotation of the electric motor and output the decelerated rotation to the movable portion, and
the motion resistance is a rotational resistance generated when a rotational force is applied to an output side of the deceleration mechanism to rotate the two or more gears.

3. The easy chair according to claim 2, wherein
the controller is configured to rotate the electric motor to assist displacement of the movable portion when the muscle strength training mode is performed.

4. The easy chair according to claim 3, further comprising an external force detector configured to detect an external force applied to the movable portion,
wherein the controller is configured to rotate the electric motor based on a magnitude of the external force detected with the external force detector.

5. The easy chair according to claim 1, further comprising a fixing portion to be directly or indirectly fixed to a vehicle.

6. A vehicle seat to be installed in a vehicle, the vehicle seat comprising:
a movable portion configured to change a seated posture;
a moving mechanism comprising at least an electric actuator and configured to displace the movable portion;
a controller configured to control an operation of the electric actuator and perform a posture change mode and a muscle strength training mode,
wherein the posture change mode is a mode that allows the movable portion to be displaced so as to change the seated posture, and
wherein the muscle strength training mode is a mode that allows a user to perform muscle strength training utilizing a motion resistance generated when the user applies a force to the movable portion to displace the movable portion.
